(19) United States
(12) Patent Application Publication
(10) Pub. No.: US 2014/0240843 A1
(43) Pub. Date: Aug. 28, 2014

(54) NEAR-EYE DISPLAY SYSTEM

(71) Applicant: Joel S. Kollin, Seattle, WA (US)

(72) Inventor: Joel S. Kollin, Seattle, WA (US)

(21) Appl. No.: 13/780,488

(22) Filed: Feb. 28, 2013

(51) Int. Cl. G02B 27/01

(52) U.S. Cl. CPC G02B 27/0172; G02B 27/0101
USPC 359/633

(57) ABSTRACT

Embodiments are disclosed herein that relate to optical systems for augmented reality display systems. For example, one disclosed embodiment provides a near-eye display system including a prism having a light input interface side configured to receive light from an image source, the prism being configured to first internally reflect the light from the image source and then emit the light from the image source out of a light output interface side of the prism after internally reflecting the light from the image source. The optical system also includes a reflective combiner positioned to receive the light emitted from the light output interface side of the prism, and to reflect the light back through the prism.

### BACKGROUND

An augmented reality display device may allow a user to view a composite view of the outside world and computer generated graphics, and thus may allow the user to interact with the outside world in new and different ways. However, current designs for augmented reality near-eye displays may suffer from too large a size and/or have a field-of-view too small to provide a satisfactory user experience. For example, some wide field of view approaches may utilize a projector with a beam splitter or off-axis optics to achieve a desired field of view. However, such designs may involve the use of a potentially larger display or optics than a consumer may tolerate. In addition, an exit pupil (location of viewer's eye pupil) of such designs may be small, which may complicate the design and use of the system.

### SUMMARY

Embodiments are disclosed herein that relate to optical systems for augmented reality display systems. For example, one disclosed embodiment provides a near-eye display system including a prism having a light input interface side configured to receive light from an image source, the prism being configured to first internally reflect the light from the image source and then emit the light from the image source out of a light output interface side of the prism. The optical system also includes a reflective combiner positioned to receive the light emitted out of the light output interface side of the prism, and to reflect the light back through the prism.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example near-eye display system according to an embodiment of the present disclosure.

FIG. 2A is a schematic depiction of an example optical system for a near-eye display system.

FIG. 2B shows paths of light through the optical system of the example of FIG. 2A.

FIG. 3A shows another example optical system for a near-eye display system.

FIG. 3B shows paths of light through the optical system of the example of FIG. 3A

FIG. 4 is a top cross-sectional view of an example near-eye display system.

FIG. 5 shows an example embodiment of a computing device.

### DETAILED DESCRIPTION

As mentioned above, current designs for augmented reality near-eye display devices may suffer from limitations in size (e.g., too large) and/or have an inadequate field-of-view that may be too small to provide a satisfactory user experience. As one possible solution, a near-eye display device may use a waveguide to channel light from collimating projection optics to the eye. This configuration may provide a relatively low profile design while expanding the exit pupil. However, such devices may have a relatively lower field of view, may utilize precise manufacturing methods with tight tolerances, and may require reinforcement of the potentially fragile waveguide structure. Further, projector optics used for such a design may occupy a relatively large amount of space.

Other devices may utilize a ‘birdbath’ approach in which a beam splitter is used with an on-axis reflector to collimate an image from a microdisplay. However, such an approach may utilize a relatively large offset between the display and the user's eye, which may make this approach undesirable in some instances.

Accordingly, embodiments are disclosed herein that relate to a near-eye display system that may combine advantages of waveguide systems (e.g. low profile, less obtrusive) with those of birdbath systems (e.g. no projection optics needed, adjustable focus possible, wider field of view). The disclosed embodiments utilize a prism having one or more total internal reflection (TIR) surfaces and/or reflective coatings to direct light received from an image source toward a reflective combiner configured combine the virtual image with a real world background image to provide an augmented reality experience.

In some embodiments, an image source may be mounted above the prism to direct light downward into the prism from the perspective of a user. The light from the image source passes into the prism along a light input interface side of the prism, undergoes a plurality of reflections within the prism, and then passes out of a light output interface side of the prism towards a reflective combiner. The light reflects from the combiner, passes back through the prism and then through a matching prism that together form a flat transparent slab to help prevent light from being refracted undesirably by the side of the prism nearest a user's eye.

The prism and matching prism may have any suitable configuration. For example, in some embodiments, the prism may be between 8 and 10 mm thick to achieve a field of view of at least 40 degrees by 23 degrees (horizontal by vertical). Other embodiments may have any other suitable dimensions and may achieve any suitable field of view. Example prisms are described in more detail below.

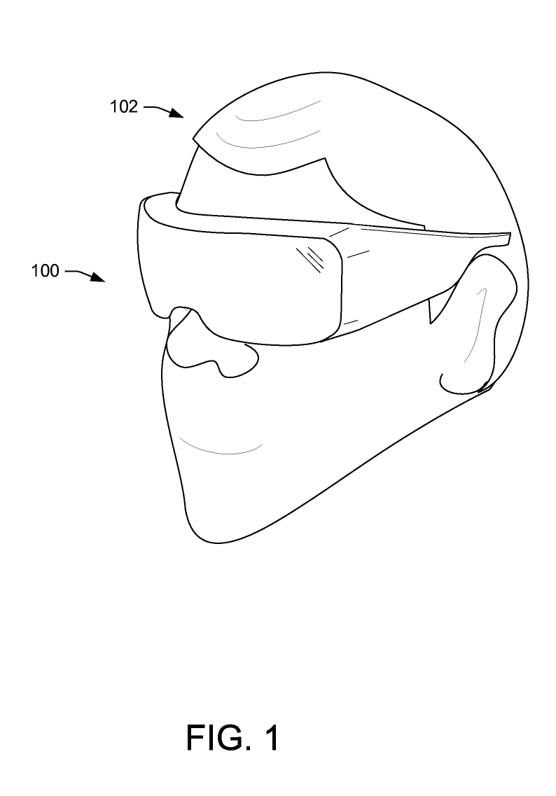

FIG. 1 shows a view of an example near-eye display 100 in the form of an augmented-reality head mounted display. In other embodiments, a near-eye display may take the form of a hand-held device configured to be held close to a user's eye, a helmet with a visor that acts as a see-through augmented reality display, and/or any other suitable form.

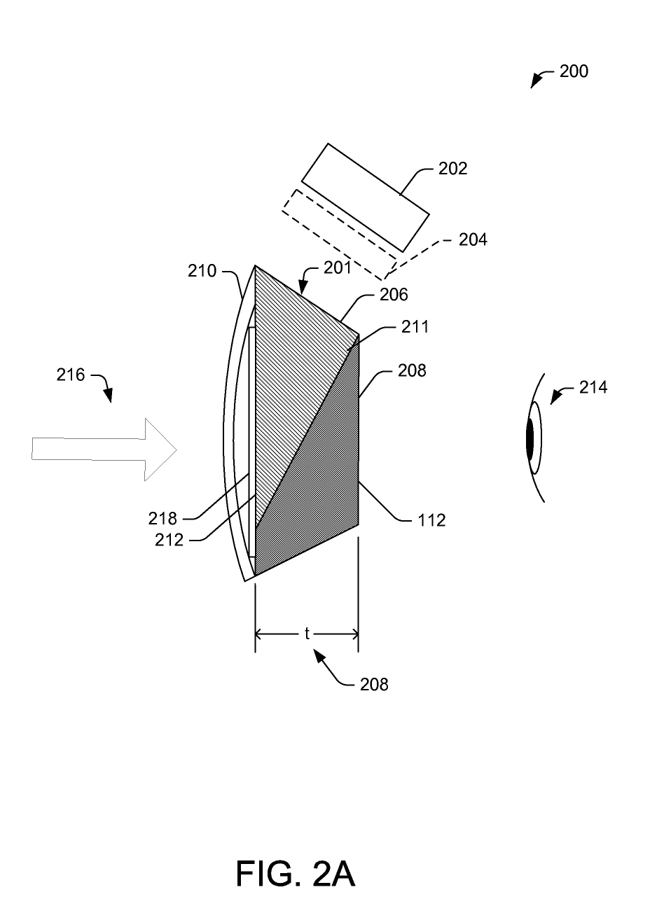

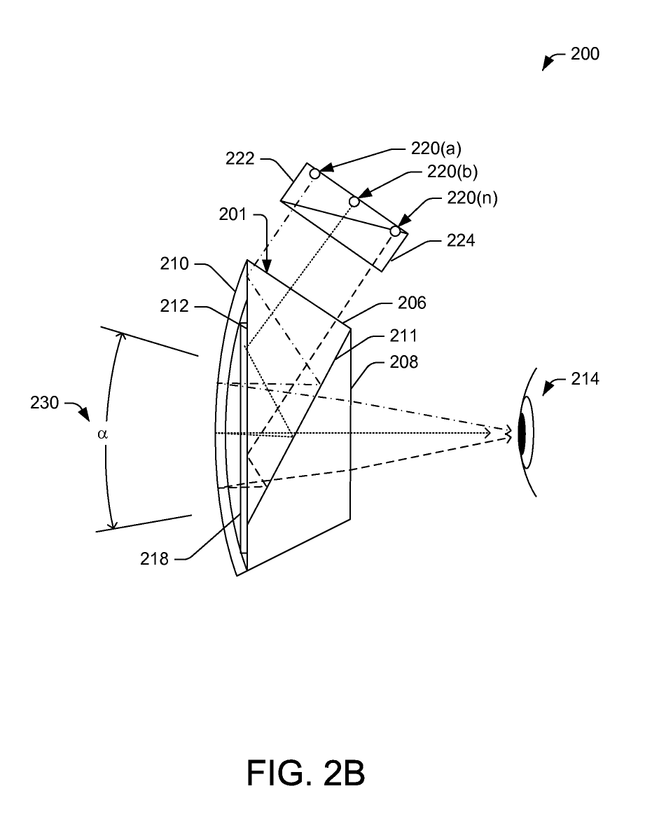

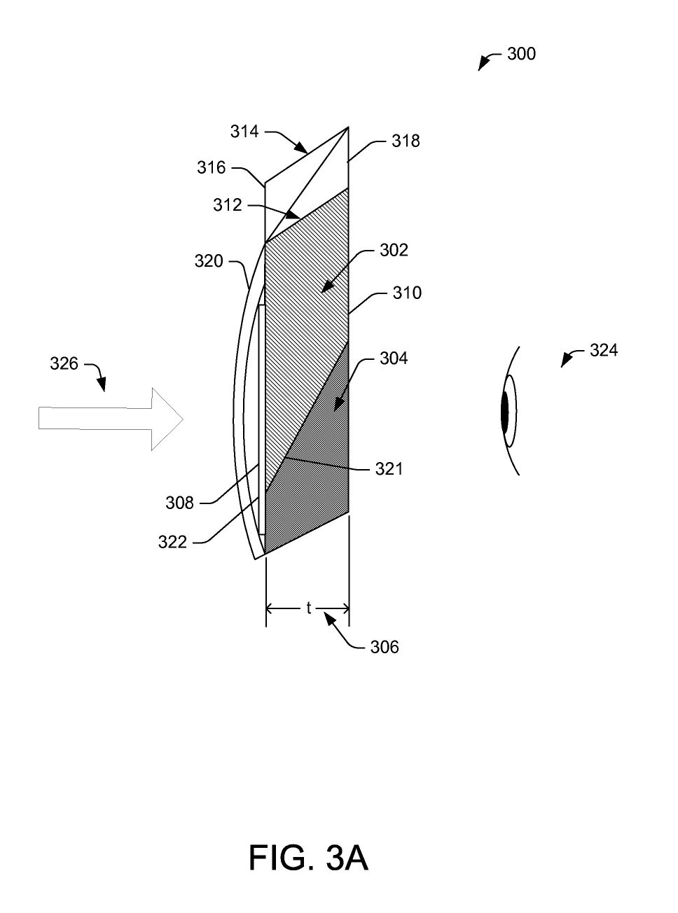

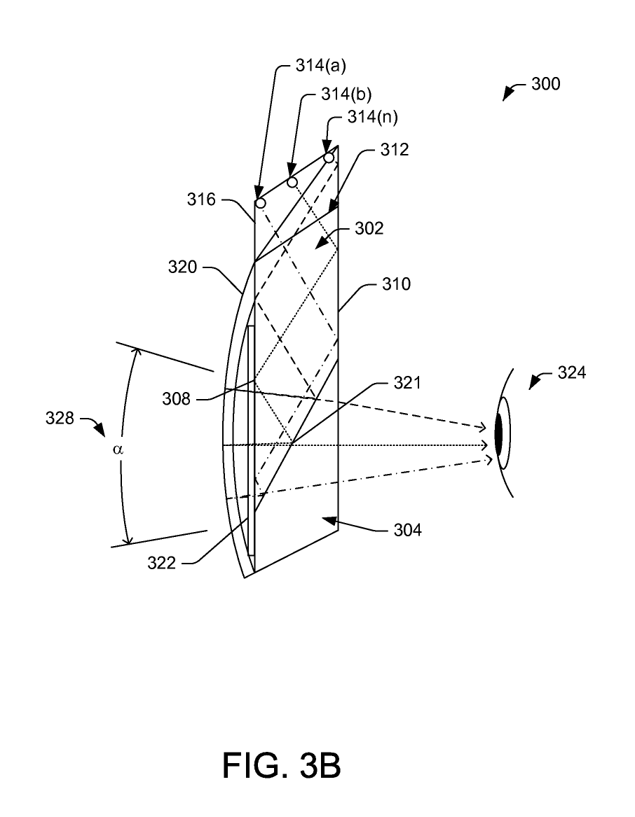

The near-eye display 100 includes a prism configured to reflect light from an image source to an eye 102 of a user. In some embodiments, the prism may comprise a triangular cross-section (as shown in FIGS. 2A and 2B), while in other embodiments, the prism may comprise a trapezoidal cross-section (as shown in FIGS. 3A and 3B). The prism is configured to redirect images produced by the image source toward a reflective combiner that reflects the image back through the prism to a user's eye(s), thereby allowing the user to view virtual images mixed with a real world background. The mixed virtual and real images may enable the user to interact with the outside world in new and different ways, such as by proving factual information, visual enhancements, games, new objects, and/or other graphical information to the user via augmented reality imagery.

The embodiments of prism-based optical systems described below for use with the near-eye display 100 may offer various advantages over other optical systems for augmented reality display devices. For example, the disclosed embodiments may have a thinner profile than a birdbath-configured system, and may use simple, on-axis optics. The prism-based systems also do not utilize gratings or other coupling structures to couple light into and out of the prism, as opposed to waveguide approaches, which may utilize reflective and/or diffractive input and output couplings.

FIG. 2A shows an example optical system 200 for a near-eye display device comprising a triangular prism 201. The optical system comprises an image source 202 configured to produce an image for display as an augmented reality image. The image source 202 may comprise any suitable type of image producing device. For example, the image source may comprise an emissive microdisplay, such as an OLED (Organic Light Emitting Device) display, and/or a reflective microdisplay, such as an LCoS (Liquid Crystal on Silicon) display or digital light processing (DLP) device. In some embodiments, a separate microdisplay may be utilized for each color of light displayed, while in other embodiments a single microdisplay may be utilized (e.g. by displaying a color field sequential image). Likewise, in some embodiments, separate image sources may be utilized for the left and right eyes of a user. This may facilitate the display of stereoscopic images. In such an embodiment, separate optical systems 200, or one or more separate components thereof, may be used to produce left-eye and right-eye images.

The image source may have any suitable location relative to other optical components. For example, in some embodiments, the image source 202 may be disposed at a top side of the near-eye display from a perspective of a user. It will be noted that uncollimated light may be input into the prism 201, as opposed to waveguide displays, which may require collimated light to be input into the waveguide. The use of uncollimated light may allow an optional focus-changing element 204 to be located between the image source 202 and a light input interface side 206 of the prism 201 through which light from the image source enters the prism 201.

In some embodiments, the prism 201 may be used in conjunction with a matching prism 208, thereby creating a slab that has parallel surfaces or substantially parallel surfaces on sides respectively facing the reflective combiner 210 and the user. The prism 201 and/or the matching prism 208 may be formed from any suitable material, including but not limited to glass materials and polymer materials. As will be described in more detail below, in some embodiments a reflective structure, such as a reflective polarizer 211, may be provided on a side of the prism 201 that interfaces with the matching prism 208. Such a reflective structure may facilitate reflection of light from the image source 202 toward the reflective combiner 210. In other embodiments, reflection may occur at this surface via total internal reflection, and the reflective polarizer 211 may be omitted.

The above-mentioned reflective combiner 210 is positioned adjacent to a light output interface side 212 of the prism 201 and separated from the prism via an air gap or other suitable structure. The reflective combiner 210 may be configured to reflect light from the image source that exits the light output interface side 212 of the prism 201 back through the prism 201 and matching prism 208 toward a user's eye 214. The reflective combiner 210 also may be configured to be at least partially transmissive to background light 216, such that a user may view a background image through the reflective combiner 210 to enable the display of augmented reality images. Further, the reflective combiner 210 may magnify and/or collimate light from the prism 201.

In embodiments that utilize a reflective polarizer 211 between the prism 201 and the matching prism 208, a quarter wave plate 218 may be positioned between the light output interface side 212 of the prism 201 and the reflective combiner 210. Thus, as light exits the prism 201 and reflects from the reflective combiner 210 back toward the user's eye 214, the light passes through the quarter wave plate 218 twice, resulting in a rotation of the polarization of the light by ninety degrees. As such, the light that previously was reflected by the reflective polarizer 211 may pass through the reflective polarizer 211 after this change of polarization.

The reflective combiner 210 may have any suitable configuration. For example, the reflective combiner may have a cylindrical profile along one or more axes, a spherical curvature, etc. Additionally, the reflective combiner may have any suitable structure to enable the reflection of light from the image source 202 and the transmission of background light 216. For example, the reflective combiner 210 may comprise a partially transmissive mirror, a reflective polarizer, a diffractive optical element (e.g. a hologram configured to reflect light in narrow wavelength bands corresponding to bands utilized in producing displayed virtual images), a dielectric minor, and/or any other partially reflective/partially transmissive structure.

The prism 201 may have any suitable configuration. For example, in some embodiments, the prism may have a thickness t of between 8 mm and 10 mm. Likewise, in some embodiments, the obtuse triangular cross-section of the prism 201 may include angles of 56×28×96 degrees, where the light output interface side 212 is opposite a largest angle of the prism. It will be understood that the prism 201 may have suitable configuration in other embodiments.

In the embodiment of FIGS. 2A-2B, light may reflect within the prism 201 two times before exiting the prism 201 through the light output interface side 212 toward the reflective combiner 210. FIG. 2B illustrates a path of light through the depicted optical system 200. More specifically, FIG. 2B shows three light rays representing an arbitrary number n of rays originating from an arbitrary set of initial locations 220(a), 220(b), 220(n) on the image source 202, wherein each location may represent a pixel on image source 202. Further, FIG. 2B also illustrates a second prism 222 and second matching prism 224 adjacent to the image source 202. The second prism 222 may reflect light from a light source toward the image source 202, while the second matching prism 224 may help to prevent light reflected by the image source 202 from being refracted or reflected away from the desired optical path. In embodiments with emissive display systems or other configurations for providing light to the image source 202, the second prism 222 and second matching prism 224 may be omitted.

Each light ray enters prism 201 via the light input interface side 206 and internally reflect from the light output interface side 212 of the prism 201. In some embodiments, this reflection may occur via total internal reflection, while in other embodiments a suitable coating may be used. This light is then reflected by the reflective polarizer 211, or via total internal reflection where the reflective polarizer (or other reflective coating) is omitted. After this second reflection within the prism 201, the light exits the prism 201 through the light output interface side 212 of the prism and is reflected by the reflective combiner 210 back toward the user's eye 214. A vertical field of view of the image from the image source, as reflected by the prism 201 to the user's eye 214, is shown as a 230. In accordance with various embodiments, the vertical field of view a 230 may be at least 19 degrees.

FIG. 3A shows another embodiment of an optical system 300 for a near-eye augmented reality display device. The optical system 300 includes a trapezoidal prism 302 and a matching prism 304. The trapezoidal prism 302 may have trapezoidal cross-sectional dimensions having a thickness t 306. In some embodiments, the thickness t 306 may be between 8 mm and 10 mm. In other embodiments, the thickness t may have a value outside of this range.

The trapezoidal prism 302 and the matching prism 304 may together create a solid slab of material that includes parallel or substantially parallel light output interface side 308 and back side 310. The trapezoidal prism 302 may have any suitable dimensions.

The trapezoidal prism 302 includes a light input interface side 312 through which light from an image source 314. In the embodiment of FIG. 3A, the image source 314 is indicated as a line on the surface of a second prism 316 and second matching prism 318. The second prism 316 is configured to reflect light from a light source toward the image source 314, and the second matching prism 318 is configured to prevent light reflected from the image source 314 from being redirected by the side of the prism 316 facing the prism 302. In other embodiments, such as embodiments that utilize an emissive microdisplay, the second prism 316 and second matching prism 318 may be omitted.

Light from image source 314 enters the light input interface side 312 of the trapezoidal prism 302. In some embodiments, the light may travel from the image source 314 directly to the trapezoidal prism 302 without passing through an air gap, while other embodiments may include an air gap and/or focus-adjusting optics between the image source 314 and the prism 302. The light may then internally reflect within the trapezoidal prism 302 three times, as described in more detail below, and then exit the prism via the light output interface side 308. Light may reflect within the prism by total internal reflection, via a reflective coating (such as a reflective polarizer), a combination of such mechanisms, or in any other suitable manner.

Light passing out of the light output interface side 308 of the prism is directed toward a reflective combiner 320. In embodiments that utilize a reflective polarizer 321 at an interface surface between the prism 302 and matching prism 304, the light may pass through a quarter wave plate 322 before reflecting from the reflective combiner 320. In embodiments in which reflections within the trapezoidal prism do not utilize a reflective polarizer, the quarter wave plate 322 may be omitted.

The reflective combiner 320 reflects the light back through the trapezoidal prism 302, through the matching prism 304 and toward an eye 324 of a user, wherein the eye 324 of the user may correspond to an exit pupil of the optical system. As mentioned above, the reflective combiner also transmits light 326 from a real-world background toward the eye 324 of a user. Thus, light 326 from the outside world and light from the image source 314 may pass through the trapezoidal prism 302.

FIG. 3B shows example paths of light through the optical system 300. More specifically, FIG. 3B shows three light rays representing an arbitrary number n of rays originating from an arbitrary set of n initial locations 314(a), 314(b), 314(n) on the image source 314, wherein each location may represent a pixel on the image source 314. The light rays enter the trapezoidal prism 302 via the light input interface side 312 and internally reflect from the back side 310 of the prism 302. In some embodiments, this reflection may occur via total internal reflection, while in other embodiments a suitable coating may be used. This light then reflects from the light output interface side 308 of the trapezoidal prism 302 via total internal reflection or a suitable coating. The light next reflects from the reflective polarizer 321, or from this surface via total internal reflection where the reflective polarizer is omitted. After this third reflection within the prism 302, the light exits the prism 302 through the light output interface side 308, and is reflected by the reflective combiner 320 toward the user's eye 324. A vertical field of view of the image from the image source, as reflected by the trapezoidal prism 302 to the eye 324 of the user, is shown as a 328.

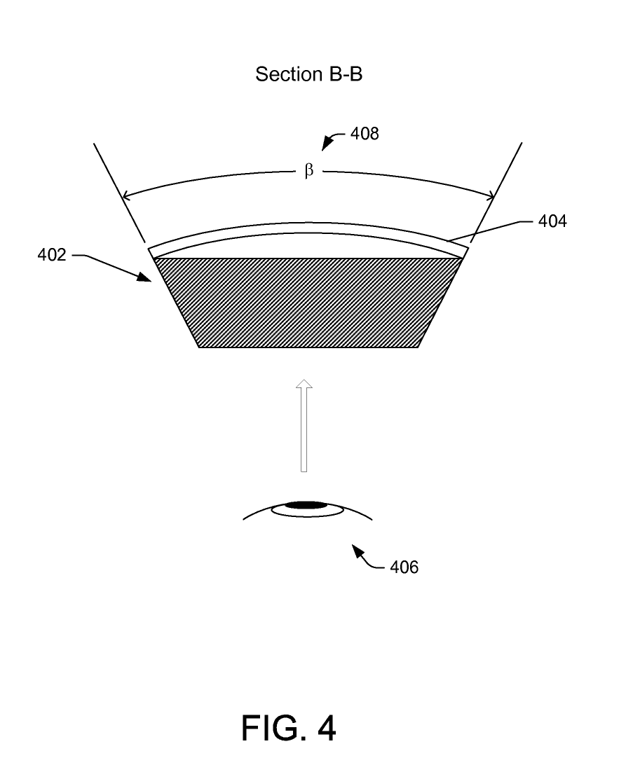

FIG. 4 shows a top sectional view of an embodiment of an optical system 400 comprising a prism 402 and a reflective combiner 404. The prism may represent prism 201 from FIGS. 2A-2B or prism 302 from FIGS. 3A-3B, and represents a view respectively looking toward light input interface sides 206 and 312. A horizontal field of view of the image from an image source, as reflected by the prism 402 to the eye pupil 406, is defined as a 408.

The disclosed embodiments may be used in conjunction with a computing system of one or more computing devices. In particular, such methods and processes may be utilized in conjunction with a computer-application program or service, an application-programming interface (API), a library, and/or other computer-program product, e.g. to effect display of an image via the disclosed optical system embodiments.

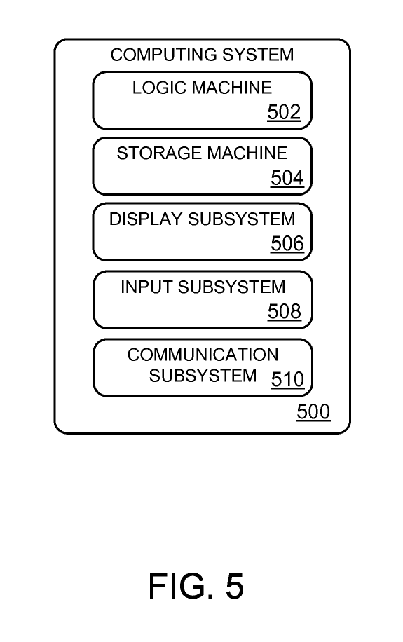

FIG. 5 schematically shows a non-limiting embodiment of a computing system 500 that can enact one or more of the methods and processes described above. Computing system 500 is shown in simplified form. Computing system 500 may take the form of a head-mounted see-through display device, as well as any other suitable computing system, including but not limited to gaming consoles, personal computers, server computers, tablet computers, home-entertainment computers, network computing devices, mobile computing devices, mobile communication devices (e.g., smart phone), and/or other computing devices.

Computing system 500 includes a logic machine 502 and a storage machine 504. Computing system 500 may also include a display subsystem 506, input subsystem 508, communication subsystem 510, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, nonvolatile, dynamic, static, read/write, read-only, random-access, sequential-access, location-addressable, file-addressable, and/or content-addressable devices.

It will be appreciated that storage machine 504 includes one or more physical devices. However, aspects of the instructions described herein alternatively may be propagated by a communication medium as a signal (e.g., an electromagnetic signal, an optical signal, etc.), as opposed to being stored on a physical device.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology, including but not limited to the near-eye display systems described herein. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, microphone, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A near-eye display system, comprising:
a prism comprising a light input interface side configured to receive light from an image source, the prism being configured to first internally reflect the light received from the image source and then emit the light from the image source out of a light output interface side of the prism after reflecting the light received from the image source; and
a reflective combiner positioned to receive the light emitted out of the light output interface side of the prism, and to reflect the light back through the prism.

2. The near-eye display system of claim 1, wherein the prism has a triangular configuration and is configured to reflect the light internally twice before emitting the light out of the light output interface side of the prism.

3. The near-eye display system of claim 2, further comprising a matching prism disposed between the prism and an exit pupil.

4. The near-eye display system of claim 1, further comprising the image source that provides the light received by the prism.

5. The near-eye display system of claim 4, wherein the image source comprises one or more of an organic light emitting diode (OLED) display or a liquid crystal on silicon (LCoS) display.

6. The near-eye display system of claim 1, wherein the prism comprises a reflective polarizer to internally reflect the light.

7. The near-eye display system of claim 6, further comprising a quarter wave plate disposed between the light output interface side of the prism and the reflective combiner.

8. The near-eye display system of claim 1, wherein the prism is configured to internally reflect the light via total internal reflection.

9. The near-eye display system of claim 1, further comprising a focus-changing element disposed between the prism and an image source.

10. The near-eye display system of claim 1, wherein the prism comprises a trapezoidal configuration.

11. The near-eye display system of claim 10, wherein the prism is configured to internally reflect the light from the image source three or more times before emitting the light from the image source toward the reflective combiner.

12. The near-eye display system of claim 1, wherein the near-eye display system comprises a head-mounted display system.

13. The near-eye display system of claim 1, wherein the reflective combiner is configured to collimate the light received from the image source.

14. An augmented reality display system, comprising:
an image source;
a triangular prism comprising a light input interface side configured to receive light from the image source, the triangular prism configured to internally reflect light received from the image source two times and then to emit the light from the image source out of a light output interface side; and
a reflective combiner configured to collimate the light and to reflect the light back through the triangular prism and towards an exit pupil.

15. The system of claim 14, wherein the triangular prism comprises a reflective polarizer.

16. The system of claim 15, further comprising a quarter wave plate disposed between the reflective combiner and the light output interface side of the prism.

17. The system of claim 11, further comprising a matching prism disposed between the triangular prism and the exit pupil.

18. An augmented reality system comprising:
an image source;
a trapezoidal prism having a light input interface side to receive light from the image source, the trapezoidal prism being configured to internally reflect the light three times and then emit the light from the image source from a light output interface side; and
a reflective combiner configured to receive the light received from the light output interface side of the trapezoidal prism, collimate the light, and reflect the light back through the trapezoidal prism and towards an exit pupil.

19. The system of claim 18, wherein the trapezoidal prism comprises a polarizing reflector.

20. The system of claim 19, further comprising a quarter wave plate disposed between the trapezoidal prism and the reflective combiner.
